(19) United States
(12) Patent Application Publication
(10) Pub. No.: US 2021/0331571 A1
(43) Pub. Date: Oct. 28, 2021

(54) VEHICLE BODY REAR STRUCTURE

(71) Applicants: TOYOTA JIDOSHA KABUSHIKI KAISHA, Aichi (JP); SUBARU CORPORATION, Tokyo (JP)

(72) Inventors: Keisuke ITOH, Nagoya-shi (JP); Ryotaro FUJIKAWA, Shibuya-ku (JP); Iwao FURUKAWA, Shibuya-ku (JP); Tomohiro MATSUMOTO, Shibuya-ku (JP)

(21) Appl. No.: 17/218,167

(22) Filed: Mar. 31, 2021

(30) Foreign Application Priority Data
Apr. 28, 2020 (JP) 2020-079693

(51) Int. Cl. B60K 1/04; B62D 25/08; B60L 15/20

(52) U.S. Cl. CPC B60K 1/04; B62D 25/08; H02K 11/33; B60K 2001/0416; B60Y 2306/01; B60L 15/20

(57) ABSTRACT

A vehicle body rear structure may include: a first electrical device disposed in a rear portion of the vehicle; and a second electrical device disposed behind the first electrical device, the second electrical device having an operating voltage lower than an operating voltage of the first electrical device. The second electrical device may be inclined such that a front end of the second electrical device is positioned higher than a rear end of the second electrical device.

### CROSS-REFERENCE TO RELATED APPLICATION

This application claims priority to Japanese Patent Application No. 2020-079693 filed on Apr. 28, 2020, the contents of which are hereby incorporated by reference into the present application.

### TECHNICAL FIELD

The art disclosed herein relates to a vehicle body rear structure having a high-voltage device (first electrical device) and a low-voltage device (second electrical device) disposed in a rear portion of a vehicle.

### BACKGROUND

Vehicles nowadays have various electrical devices mounted thereon. A plurality of electrical devices may be disposed in a rear portion of a vehicle. For example, a vehicle described in Japanese Patent Application Publication No. 2011-006050 includes a battery charger disposed in a rear portion of the vehicle. A vehicle described in Japanese Patent Application Publication No. 2015-009588 includes a battery, an inverter, and an electric fan disposed in a rear portion of the vehicle. Japanese Patent Application Publication No. 2017-056861 describes a structure in which an electrical device disposed in a rear portion of a vehicle moves downward when an object collides with the vehicle from behind. Due to the electrical device moving downward, the electrical device is prevented from protruding into a rear seat.

### SUMMARY

There is a case in which a high-voltage device is disposed in a rear portion of a vehicle and a low-voltage device is disposed behind the high-voltage device. When an object collides with this vehicle from behind, the low-voltage device may be pushed frontward and may come into contact with the high-voltage device. Also, the low-voltage device may push another device frontward and this other device may come into contact with the high-voltage device. The disclosure herein relates to a vehicle body rear structure having a low-voltage device disposed behind a high-voltage device in a rear portion of a vehicle. The art disclosed herein reduces a damage which the high-voltage device receives when an object collides with the vehicle from behind.

The disclosure herein discloses a structure which comprises a first electrical device (high-voltage device) and a second electrical device (low-voltage device) disposed in a rear portion of a vehicle. The second electrical device is disposed behind the first electrical device. An operating voltage of the second electrical device is lower than an operating voltage of the first electrical device. The second electrical device may be inclined such that a front end of the second electrical device is positioned higher than a rear end of the second electrical device. When an object collides with the vehicle from behind, the second electrical device may be pushed frontward. The second electrical device in a posture having its front end positioned higher than its rear end moves frontward while rotating such that its front end may be lifted upward. The front end of the second electrical device may move in a diagonally upward direction. Due to this, the second electrical device may be prevented from coming into contact with the first electrical device straight in a horizontal direction. A damage which the first electrical device receives may be reduced.

The vehicle body rear structure disclosed herein may further comprise a crossmember arranged between the first electrical device and the second electrical device, and a front bracket connecting a rear upper portion of the crossmember and the front end of the second electrical device to each other. When the object collides with the vehicle from behind, the second electrical device may be pushed frontward and the front bracket may thereby deform. The second electrical device may be guided by the deforming front bracket such that its front end moves upward, as a result of which the front end of the second electrical device may move upward toward a position above the crossmember. Collision of the second electrical device with the first electrical device may be prevented.

When the second electrical device comes into contact with the crossmember while rotating, a damage which the crossmember receives may be reduced. The crossmember does indeed deform by receiving the damage, however, its degree of deformation may be small since the damage may be small. Since the degree of deformation of the crossmember may be small, even if the deformed crossmember comes into contact with the first electrical device, a damage which the first electrical device receives may be thereby small.

The rear upper portion of the crossmember may be positioned higher than the first electrical device. In this configuration, the second electrical device may not collide with the first electrical device even when it moves frontward over the crossmember.

The front bracket may be connected to a front lower end of the second electrical device. Since the front lower end of the second electrical device may be guided by the deforming front bracket and may reach the rear upper portion of the crossmember, the front end of the second electrical device may be ensured to move to a position above the crossmember.

A rear lower end of the second electrical device may be supported by a vehicle body. When the object collides with the vehicle from behind, the rear lower end of the second electrical device may be pushed frontward. The second electrical device is further facilitated to rotate such that its front end may be lifted up.

A rear end of the second electrical device may be supported by the vehicle body via the rear bracket, and the rear bracket may have a shape in which its rear portion is upwardly bent. When pressed from behind, the rear bracket may further bend, and may thereby push down the rear end of the second electrical device. Deformation of the rear bracket may contribute to rotation of the second electrical device.

A typical example of the first electrical device may be an inverter configured to supply electric power to an electric traction motor for driving a rear wheel, and a typical example of the second electrical device may be a controller of the inverter. Details and further improvements of the technique disclosed herein will be described in Detailed Description below.

### BRIEF DESCRIPTION OF DRAWINGS

FIG. 1 is a plan view of a rear portion of a vehicle.

FIG. 2 is a side view of the rear portion of the vehicle.

FIG. 3 is a cross-sectional view cut along a line III-III of FIG. 1.

FIG. 4 is a diagram showing a movement of a controller when a collision load is applied from behind.

FIG. 5 is a cross-sectional view of a vehicle body rear structure of a second embodiment.

FIG. 6 is a diagram showing a movement of a controller in the vehicle body rear structure of the second embodiment.

### DETAILED DESCRIPTION

The terms “high-voltage device” and “low-voltage device” described herein will be defined. A high-voltage device is defined by US federal regulation, Federal Motor Vehicle Safety Standards 305 (FMVSS305). According to the definition, a high-voltage device refers to an electrical device included in an electric powertrain of an electric vehicle or electrically connected to the electric powertrain, and having an operating voltage exceeding AC 30[V] or exceeding DC 60[V]. Further, in the disclosure herein, an electrical device having an operating voltage below AC 30[V] or below DC 60[V] is termed a low-voltage device. Examples of the high-voltage device are an electric traction motor and an inverter configured to supply AC electric power to the electric traction motor. Examples of the low-voltage device are a controller configured to provide instructions to the inverter, a car audio system, and a navigation device.

The electric vehicle described herein refers to vehicles provided with electric traction motors. That is, the electric vehicle herein may include a hybrid vehicle having an electric traction motor and an engine, a fuel cell vehicle having a battery and a fuel cell as power sources for an electric traction motor, and a vehicle having a capacitor as a power source for an electric traction motor.

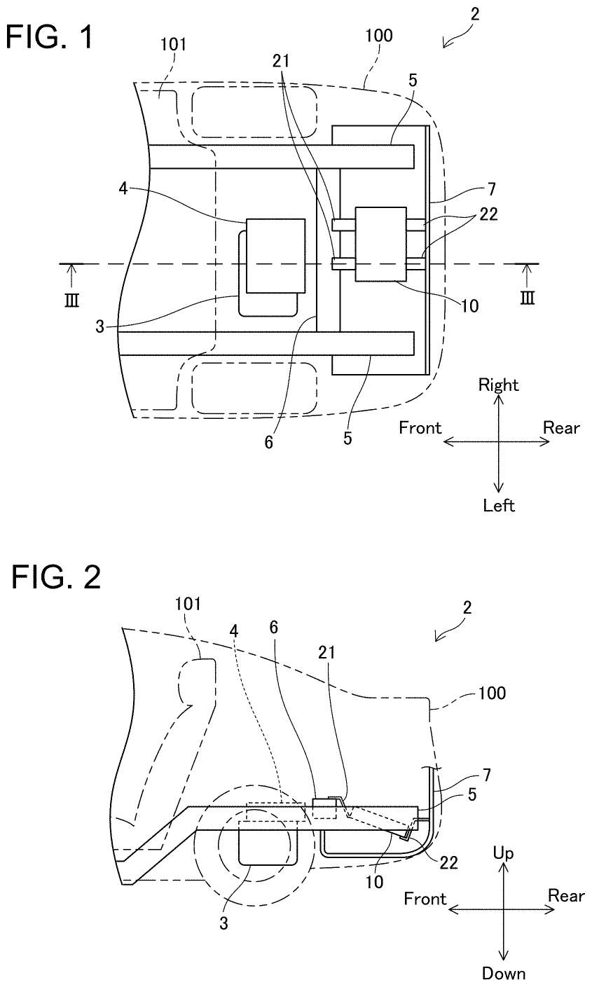

(First Embodiment) A vehicle body rear structure 2 of a first embodiment will be described with reference to the drawings. FIG. 1 shows a plan view of a rear portion of a vehicle 100. FIG. 2 shows a side view of the rear portion of the vehicle 100. “Front”, “Rear”, “Right”, and “Left” in the coordinate system of FIG. 1 are defined with respect to the vehicle. Further, “Up” and “Down” in the coordinate system of FIG. 2 are also defined with respect to the vehicle. In FIGS. 1 and 2, an outline of the vehicle 100 is depicted by phantom lines so that an arrangement of primary devices inside the vehicle 100 is visible.

The vehicle 100 of the embodiment is an electric vehicle provided with a rear electric traction motor (rear motor 3) configured to drive rear wheels. Although the depiction is omitted, the vehicle 100 is also provided with a front electric traction motor configured to drive front wheels. An inverter 4 is disposed on the rear motor 3. The inverter 4 is configured to supply three-phase alternating current to the rear motor 3. The rear motor 3 and the inverter 4 are disposed in the rear portion of the vehicle. A controller 10 is also disposed in the rear portion of the vehicle. The controller 10 is configured to control the inverter 4. The rear portion of the vehicle described herein refers to a portion rearward of a rear seat 101.

An output of the rear motor 3 is 10 [kW] or more, and the inverter 4 is configured to supply electric power of 10 [kW] or more to the rear motor 3. Operating voltages of the rear motor 3 and the inverter 4 exceed AC 30[V]. The rear motor 3 is an electrical device included in an electric powertrain, and the inverter 4 is an electrical device electrically connected to the electric powertrain (rear motor 3). That is, the rear motor 3 and the inverter 4 are classified as high-voltage devices.

On the other hand, the controller 10 is a device configured to provide commands to the inverter 4, and is a circuit primarily of TTL (Transistor-Transistor Logic). Since an operating voltage of the controller 10 is less than 30[V], the controller 10 is classified as a low-voltage device.

The rear motor 3, the inverter 4, and the controller 10 are disposed between a pair of rear side members 5 extending in a vehicle front-rear direction. The rear motor 3 and the inverter 4 are disposed frontward of a crossmember 6, and the controller 10 is disposed rearward of the crossmember 6.

The crossmember 6 is a beam member extending in a vehicle lateral direction between the pair of rear side members 5 and connected to each of the pair of rear side members 5.

The controller 10 is supported by the crossmember 6 via front brackets 21, and supported by a lower back panel 7 via rear brackets 22. The lower back panel 7 is connected to a rear floor panel (not shown) or the rear side members 5, and defines a boundary of a rear lower portion of a trunk room. The lower back panel 7 is a part of a vehicle body.

As shown in FIGS. 1 and 2, the controller 10 is located behind the inverter 4 in both a height direction and a vehicle width direction. The crossmember 6 extends between the inverter 4 and the controller 10. In other words, the crossmember 6 passes through between the inverter 4 and the controller 10.

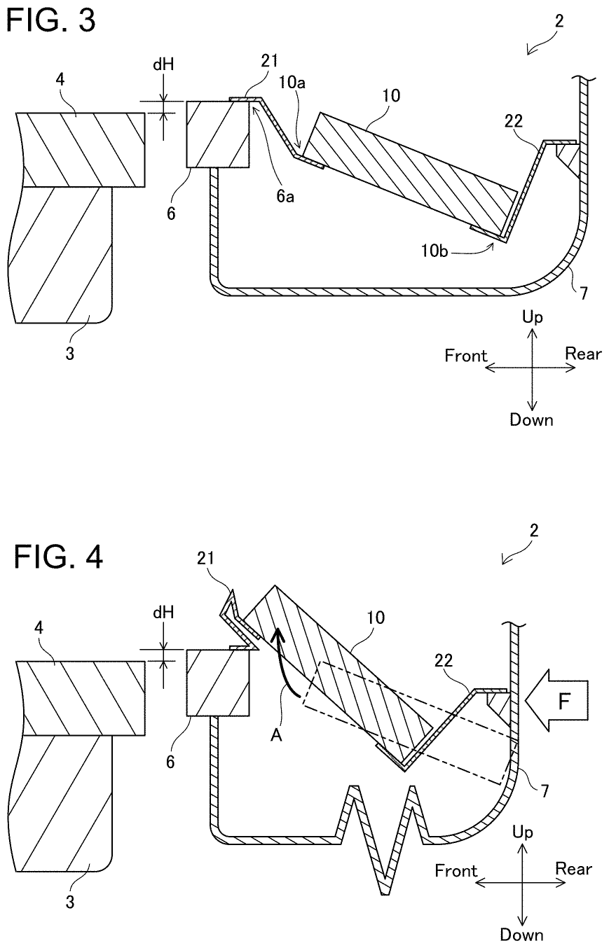

FIG. 3 shows a cross-sectional view along a line III-III of FIG. 1. In FIG. 3, depiction of the outline of the vehicle 100 is omitted.

As aforementioned, the controller 10 is supported by the crossmember 6 via the front brackets 21 and supported by the lower back panel 7 (that is, the vehicle body) via the rear brackets 22. The controller 10 is supported by the front brackets 21 and the rear brackets 22 such that a front end of the controller 10 is positioned higher than a rear end thereof. Further, the front brackets 21 connect a rear upper portion 6a of the crossmember 6 and a front lower end 10a of the controller 10 to each other. The rear brackets 22 connect a rear lower end 10b of the controller 10 to the lower back panel 7.

The inverter 4 is a high-voltage device, and it is desirable that a damage thereto in a collision is reduced. The inverter 4 is disposed in the rear portion of the vehicle, and the controller 10 is disposed behind the inverter 4. When an object collides with the vehicle from behind, the controller 10 is pushed frontward, as a result of which, the controller 10 may come into contact with the inverter 4. The crossmember 6 passes through between the controller 10 and the inverter 4. When the controller 10 collides with the crossmember 6, the crossmember 6 may thereby deform. This deformed crossmember 6 may come into contact with the inverter 4 as well. According to a support structure (the vehicle body rear structure 2) of the controller 10 as aforementioned, when the object collides with the vehicle from behind, the damage which the inverter 4 receives by coming into contact with the controller 10 and/or the crossmember 6 can be reduced.

FIG. 4 shows a movement of the controller 10 when the object collides with the vehicle from behind. In other words, FIG. 4 shows the movement of the controller 10 when a collision load F is applied to the vehicle 100 from behind. FIG. 4 shows a cross section corresponding to FIG. 3. A phantom line in FIG. 4 shows a position where the controller 10 had been before collision.

When the collision load F is applied, the lower back panel 7 deforms and moves frontward. When the collision load F is applied, the controller 10 is pushed frontward via the rear brackets 22. When the controller 10, which is inclined such that its front end is positioned higher than its rear end, is pushed from behind, it moves frontward while rotating such that its front end is lifted upward. An arrow line A in FIG. 4 shows movement of the front end. The front end of the controller 10 moves frontward and upward. The crossmember 6 extends through a space between the controller 10 and the inverter 4. The front end of the controller 10 moves in a diagonally upward direction. The front end of the controller 10 is prevented from colliding straight with a rear surface of the crossmember 6 in a horizontal direction. Due to this, a damage which the crossmember 6 receives can be reduced. The crossmember 6 may deform by the damage and may come into contact with the inverter 4. However, since the damage which the crossmember 6 receives is reduced, deformation of the crossmember 6 is also mitigated. As a result, the damage which the inverter 4 receives can also be reduced.

The front lower end 10a of the controller 10 and the rear upper portion 6a of the crossmember 6 are connected to each other by the front brackets 21. When the controller 10 is pushed frontward, the front brackets 21 thereby deform. The controller 10 is guided by the deforming front brackets 21 such that its front end moves upward, and the front end of the controller 10 moves toward a position above the crossmember 6 (FIG. 4). The front end of the controller 10 moves away from the crossmember 6. The damage which the crossmember 6 receives can further be reduced. As a result, the damage which the inverter 4 receives can also be reduced. A structure in which the front lower end 10a of the controller 10 and the rear upper portion 6a of the crossmember 6 are connected to each other contributes to protection of the inverter 4.

The rear lower end 10b of the controller 10 is supported by the lower back panel 7 via the rear brackets 22. When the collision load is applied from behind, the rear lower end 10b of the controller 10 is pushed frontward. This force further promotes rotation of the controller 10. Thus, the front end of the controller 10 is swiftly lifted up. A structure in which the rear lower end 10b of the controller 10 is supported also contributes to the protection of the inverter 4.

The rear upper portion 6a of the crossmember 6 is positioned at a height that is higher than or equal to that of the inverter 4. A distance dH in FIGS. 3 and 4 indicates a height difference between the inverter 4 and the rear upper portion 6a of the crossmember 6. Since the crossmember 6 is positioned at the height that is higher than or equal to that of the inverter 4, the controller 10 may not collide with the inverter 4 even when it moves frontward over the crossmember 6.

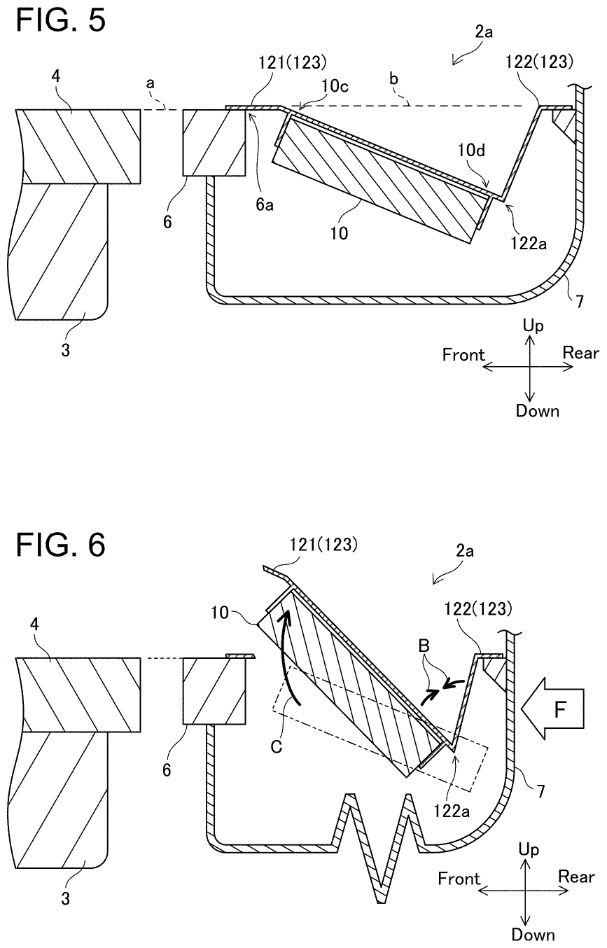

(Second Embodiment) FIG. 5 shows a cross-sectional view of a vehicle body rear structure 2a of a second embodiment. FIG. 6 shows a movement of the controller 10 when the object collides with the vehicle from behind. A phantom line in FIG. 6 shows the position where the controller 10 had been before the collision.

In the vehicle body rear structure 2a of the second embodiment, the controller 10 is supported by the crossmember 6 and the lower back panel 7 by a bracket 123. A front half of the bracket 123 corresponds to a bracket 121 and a rear half thereof corresponds to a rear bracket 122. The front bracket 121 connects the rear upper portion 6a of the crossmember 6 and a front upper end 10c of the controller 10 to each other. The rear bracket 122 connects a rear upper end 10d of the controller 10 to the lower back panel 7.

In the vehicle body rear structure 2a, as shown by a broken line a, the inverter 4 and the crossmember 6 are positioned at the same height. Further, as shown by a broken line b, a connecting point between the front bracket 121 and the crossmember 6 and a connecting point between the rear bracket 122 and the lower back panel 7 are at the same height as well.

A rear portion of the rear bracket 122 is upwardly bent at a corner 122a. As shown in FIG. 6, when the collision load F is applied from behind, the lower back panel 7 deforms frontward. A rear end of the rear bracket 122 is pushed frontward, and the rear bracket 122 further bends (arrow lines B). Deformation (bending) of the rear bracket 122 assists the rotation of the controller 10 (rotation by which its front end is lifted up; arrow line C). Due to this, the front end of the controller 10 may be further lifted up, and the contact with the crossmember 6 may be thereby avoided. The vehicle body rear structure 2a of the second embodiment also protects the inverter 4 from a collision impact.

Some points of the art described in the embodiments will be described. The inverter 4 corresponds to an example of a first electrical device, and the controller 10 corresponds to an example of a second electrical device. The first electrical device is not limited to the inverter 4. The second electrical device is not limited to the controller 10.

It is desirable that a front bracket is connected to the front lower end 10a of the controller 10 (second electrical device), however, it may be connected to the front upper end 10c of the controller 10 as with the front bracket 121 of the vehicle body rear structure 2a of the second embodiment.

The rear upper portion 6a of the crossmember 6 may be at the height equal to that of the inverter 4 (first electrical device), or alternatively, it may only need to be positioned higher than the inverter 4.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A vehicle body rear structure comprising:
a first electrical device disposed in a rear portion of the vehicle; and
a second electrical device disposed behind the first electrical device, the second electrical device having an operating voltage lower than an operating voltage of the first electrical device,
wherein the second electrical device is inclined such that a front end of the second electrical device is positioned higher than a rear end of the second electrical device.

2. The vehicle body rear structure of claim 1, further comprising:
a crossmember arranged between the first electrical device and the second electrical device; and
a front bracket connecting a rear upper portion of the crossmember and the front end of the second electrical device to each other.

3. The vehicle body rear structure of claim 2, wherein the rear upper portion of the crossmember is positioned higher than the first electrical device.

4. The vehicle body rear structure of claim 2, wherein the front bracket is connected to a front lower end of the second electrical device.

5. The vehicle body rear structure of claim 1, wherein a rear lower end of the second electrical device is supported by a vehicle body.

6. The vehicle body rear structure of claim 1, further comprising:
a rear bracket connecting the rear end of the second electrical device and the vehicle body to each other, wherein the rear bracket has an upwardly bent rear portion.

7. The vehicle body rear structure of claim 1, wherein the first electrical device is an inverter configured to supply electric power to an electric traction motor for driving a rear wheel and the second electrical device is a controller of the inverter.
